(19) United States
(12) Patent Application Publication
(10) Pub. No.: US 2019/0086354 A1
(43) Pub. Date: Mar. 21, 2019

(54) HUMIDITY SENSOR

(71) Applicants: INCHANG ELECTRONICS CO., LTD., Anyang-si (KR); KOREA ELECTRONICS TECHNOLOGY INSTITUTE, Seongnam-si (KR)

(72) Inventors: Jung Hun YOO, Seoul (KR); Jin Min LEE, Seoul (KR); Sung Min HONG, Yongin-si (KR); Won Hyo KIM, Yongin-si (KR)

(73) Assignees: INCHANG ELECTRONICS CO., LTD., Anyang-si (KR); KOREA ELECTRONICS TECHNOLOGY INSTITUTE, Seongnam-si (KR)

(21) Appl. No.: 15/788,714

(22) Filed: Oct. 19, 2017

(30) Foreign Application Priority Data
Sep. 18, 2017 (KR) 10-2017-0119843

(51) Int. Cl. G01N 27/22

(52) U.S. Cl. CPC G01N 27/225; G01N 27/221

(57) ABSTRACT

Provided is a humidity sensor including a substrate, a lower electrode, a humidity-sensitive dielectric portion, and an upper electrode which are sequentially stacked and measuring humidity by sensing a difference in capacitance between electrodes according to a change in dielectric constant of the humidity-sensitive dielectric portion, wherein the humidity-sensitive dielectric portion has a plurality of cylindrical members having a circular or C-shaped cross-section erected on the lower electrode, and wherein the upper electrode has a pattern where a plurality of circular-rings or C-rings in contact with ceiling surfaces of the plurality of the cylindrical members of the humidity-sensitive dielectric portion are connected to each other.

This application claims the benefit of Korean Patent Application No. 10-2017-0119843, filed on Sep. 18, 2017, the contents of which are hereby incorporated by reference herein in their entirety.

### BACKGROUND OF THE INVENTION

### Field of the Invention

The present invention relates to a humidity sensor for detecting humidity with a change in capacitance according to humidity, and more particularly, to a humidity sensor having sensitivity irrespective of a direction in which the humidity sensor is installed.

### Description of the Related Art

Generally, a sensor is an element having a function of detecting or determining various types of physical quantities such as temperature, pressure, sound, or light and transmitting a signal, or a measuring instrument using such a device. In particular, a sensor that detects moisture in the air is referred to as a humidity sensor.

Such a humidity sensor is manufactured with various structures, and a structure configured with a thin film for detecting moisture and using a change in electrical conductivity when the thin film is exposed to moisture is mainly used.

In some cases, a polymer thin film made of polyimide or the like may be used as a humidity-sensitive layer, which has recently been used as a material for replacing an existing thin film. However, since it is difficult to obtain electrical characteristics by using the polymer thin film itself, a polymer thin film is formed on another thin film, and a phenomenon is used where a shape of the lower thin film is changed by deformation of the polymer thin film, and thus, electrical characteristics are changed.

FIGS. 1 and 2 are perspective views illustrating a structure of a capacitive absolute humidity sensor in the related art.

As illustrated in FIG. 1, an insulating film 12 made of SiO₂, Si₃N₄, SiOₓN_{y}, or the like is formed on a silicon substrate 11, and a metal film such as Al or Pt is deposited and patterned on the insulating film 12 to form a lower electrode 13 for a humidity-sensitive element and a lower electrode 13′ for a compensation element. Next, a polyimide thin film is spin-coated and patterned on the lower electrodes 13 and 13′ to form a humidity-sensitive layer 14 for the humidity-sensitive element and a humidity-sensitive layer 14′ for the compensation element, and thermal treatment is performed at a temperature of about 200 to 300° C.

Next, a metal film of the same material as the lower electrodes 13 and 13′ is deposited and patterned on the polyimide humidity-sensitive layers 14 and 14′ to form a comb-shaped upper electrode 15 for a humidity-sensitive element and a combs-shaped upper electrode 15′ for a compensation element, so that a parallel plate capacitor structure having a polyimide humidity-sensitive layer formed between the upper electrode and the lower electrode is obtained.

The water vapor comes directly in contact with the exposed polyimide humidity-sensitive layer between the upper electrodes to penetrate into the thin film. The polyimide has a relative dielectric constant of 3 to 4 at the room temperature and a dielectric property with a dissipation factor value of about 0.001 to 0.003 at a frequency of 1 kHz.

Since the polyimide humidity-sensitive layer acts as a dielectric portion of a capacitor, if water molecules having a relative dielectric constant of 80 penetrate into the polyimide thin film, the water molecules existing inside the polyimide thin film form a dielectric mixture having different dielectric constants. Therefore, the relative dielectric constant of the dielectric mixture is changed according to a change in the ambient humidity, so that a change in the humidity can be detected.

Finally, a ceramic thin film such as SiO₂, Si₃N₄, and SiOₓN_{y} is deposited and patterned to form a protective film 16 above the humidity-sensitive layer 14′ for the compensation element and the upper electrode 15′ so that moisture cannot penetrate into the humidity-sensitive layer 14′.

According to the embodiment, the comparative structure using the compensation element may be omitted, but it is advantageous to have the comparative structure using the compensation element in terms of accuracy.

With respect to the capacitive polymer humidity sensor in the related art, the sensor characteristics such as sensitivity are determined according to inherent properties of the polymer. However, the capacitive polymer humidity sensor has a sandwich structure where a polymer which is a humidity-sensitive layer is inserted between the two electrodes, and thus, it is difficult to improve the sensitivity of the humidity-sensitive layer.

In addition, the pattern of the comb-shaped upper electrode 15 for a humidity-sensitive element causes the following problem of non-uniformity in sensitivity. Since the upper electrode 15 is hard to penetrate moisture, the humidity becomes an obstacle to movement of the moisture to the humidity-sensitive layer 14. Between the case where the flow of the air containing humidity is parallel to the comb direction and the case where the flow of the air is perpendicular to the comb direction, there occurs a difference in the degree of movement of the moisture in the humidity-sensitive layer 14.

As a result, the humidity sensor illustrated in the figure has a non-uniform sensitivity to the direction of air flow at the installation position.

In addition, the pattern of the comb-shaped upper electrode 15 for the humidity-sensitive element causes a problem of deteriorating the flexibility in both of the comb direction and the perpendicular direction.

### SUMMARY OF THE INVENTION

The present invention is to provide a humidity sensor having improved sensitivity to humidity in the air.

The present invention is to provide a humidity sensor with high flexibility.

The present invention is to provide a humidity sensor with excellent responsivity.

The present invention is to provide a humidity sensor having sensitivity/responsivity independent of the direction of air flow at the installation position of the sensor.

### Means for Solving the Problems

According to an aspect of the present invention, there is provided a humidity sensor including a substrate, a lower electrode, a humidity-sensitive dielectric portion, and an upper electrode which are sequentially stacked and measuring humidity by sensing a difference in capacitance between electrodes according to a change in dielectric constant of the humidity-sensitive dielectric portion, wherein the humidity-sensitive dielectric portion has a plurality of cylindrical members having a circular or C-shaped cross-section erected on the lower electrode, and wherein the upper electrode has a pattern where a plurality of circular-rings or C-rings in contact with ceiling surfaces of the plurality of the cylindrical members of the humidity-sensitive dielectric portion are connected to each other.

Herein, the plurality of C-rings may be formed such that a total sum of vectors of the C-ringed opening directions with respect to a center point thereof is zero.

Herein, a shape of distribution of interconnection portions of the plurality of circular-rings or C-rings may be a shape where sides constituting a regular polygon are distributed in the same number.

Herein, a width of interconnection portions of the plurality of circular-rings or C-rings may have a value of 0.5 to 1 times the width of the circular-ring or C-ring.

Herein, an area porosity of patterns where the plurality of circular-rings or C-rings of the upper electrode are connected to each other may be in a range of 30% to 60%.

Herein, the humidity-sensitive dielectric portion is made of a polyimide-based polymer, and an etching depth may be in a range of 20% to 80% of a thickness of the humidity-sensitive dielectric portion.

The capacitive humidity sensor according to the present invention having the above-described configuration has an advantage in that sensitivity to humidity in the air can be increased.

The capacitive humidity sensor according to the present invention has an advantage of high flexibility. Namely, the capacitive humidity sensor according to the present invention is advantageous in that the humidity sensor has a high humidity sensing efficiency and is flexible and invulnerable to an external bending force.

The capacitive humidity sensor according to the present invention has an advantage of excellent responsivity. In addition, the capacitive humidity sensor has an advantage of a constant responsivity irrespective of the direction of the air flow at the installation position of the sensor.

### BRIEF DESCRIPTION OF THE DRAWINGS

FIGS. 1 and 2 are perspective views illustrating a structure of a capacitive absolute humidity sensor in the related art;

FIG. 3 is a plan view illustrating a top surface pattern of one sensing block constituting a capacitive humidity sensor according to an embodiment of the present invention;

FIG. 4A is a plan view illustrating an enlarged structure for a partial region of the sensing blocks in FIG. 3;

FIG. 4B is a side cross-sectional view of a region A illustrated in FIG. 4A;

FIG. 4C is a side cross-sectional view of a region B illustrated in FIG. 4A;

FIGS. 5A and 5B are perspective views illustrating a state where a bending operation is applied to a partial region of the sensing block illustrated in FIG. 3;

FIG. 6A is a plan view illustrating an enlarged structure for a partial region of a modified example in which the entire humidity-sensitive dielectric portion is formed in a sheet shape;

FIG. 6B is a side cross-sectional view of a region A illustrated in FIG. 6A;

FIG. 6C is a side cross-sectional view of a region B illustrated in FIG. 6A;

FIG. 7 is an enlarged plan view illustrating a top surface pattern of a partial region of one sensing block constituting a capacitive humidity sensor according to another embodiment of the present invention;

FIG. 8A is a side cross-sectional view of a region A illustrated in FIG. 7;

FIG. 8B is a side cross-sectional view of a region B illustrated in FIG. 7;

FIGS. 9A and 9B are perspective views illustrating a state where a bending operation is applied to a partial region of the sensing block illustrated in FIG. 7;

FIGS. 10 and 11 are plan views illustrating a top surface pattern of one sensing block constituting a capacitive humidity sensor according to still another embodiment of the present invention;

FIGS. 12 and 13 are plan views illustrating a top surface pattern of one sensing block constituting a capacitive humidity sensor according to further still another embodiment of the present invention; and

FIG. 14 is a plan view illustrating a top surface pattern of one sensing block constituting a capacitive humidity sensor according to yet further still another embodiment of the present invention.

### DETAILED DESCRIPTION OF THE INVENTION

Hereinafter, embodiments of the present invention will be described with reference to the accompanying drawings.

In describing the present invention, the terms first, second, or the like may be used to describe various elements, but the elements may not be limited by terms. Terms are used for the purpose of distinguishing components from others. For example, without departing from the scope of the present invention, a first component may be referred to as a second component, and similarly, a second component may also be referred to as a first component.

It is to be understood that, in the case where an element is disclosed as being connected to another element, the element may be directly connected to another element, or still another element may be located between the element and another element

The terms used herein are for the purpose of describing only specific embodiments, but the terms are not intended to limit the invention. A component expressed as singular may include plural components unless the context clearly expresses otherwise.

It is to be understood that the term “include” or “have” as used herein is intended to specify the presence of features, numerals, steps, operations, components, parts, or combinations thereof, but the terms is not intended to exclude the presence or addition of one or more features, numerals, steps, operations, components, parts, or combinations thereof.

In addition, shapes, sizes, and the like of components in the drawings may be exaggerated for the clear description.

A capacitive humidity sensor according to an aspect of the present invention is a humidity sensor which includes a substrate, a lower electrode, a humidity-sensitive dielectric portion, and an upper electrode sequentially stacked and measures humidity by sensing a difference in capacitance between electrodes according to a change in dielectric constant of the humidity-sensitive dielectric portion.

In the capacitive humidity sensor, the humidity-sensitive dielectric portion is configured with a plurality of cylindrical members having a circular-ringed or C-ringed cross-section erected on the lower electrode. In the capacitive humidity sensor, the upper electrode is configured with a pattern where a plurality of circular-rings or C-rings in contact with ceiling surfaces of the plurality of the cylindrical members of the humidity-sensitive dielectric portion are connected to each other.

First, a method of manufacturing a humidity sensor according to the present invention will be described.

A capacitive humidity sensor according to an embodiment of the present invention is configured to include a substrate, a lower electrode, a humidity-sensitive dielectric portion, and an upper electrode.

The substrate is advantageously configured with a flexible substrate invulnerable to external impact as a substrate for fixing and supporting the lower electrode, the humidity-sensitive dielectric portion, and the upper electrode. For example, the substrate may be configured by using any one of a silicon substrate, a glass substrate, and a polymer film. For example, the substrate may be configured with one selected from a group including polyurethane acrylate, polyethylene glycol diacrylate, polystyrene, polymethyl methacrylate, polyimide, polyether imide, polycarbonate, polyethylene, polyether sulfone, polyethylene naphthalate, polyethylene terephthalate, polypropylene, polyester, and polydimethyl siloxane (PDMS) or a mixture of two or more thereof.

The lower electrode is formed on the substrate and outputs an electric signal according to the capacitance together with the upper electrode to be described later. According to the embodiment, the substrate is an ROIC substrate including an electrode pad. A metal layer is formed above the ROIC substrate between the substrate and the lower electrode and patterned to expose a portion of the electrode pad. And an insulating layer is formed on the metal layer and patterned to expose a portion of the electrode pad.

The lower electrode may be deposited on the substrate by using an electron beam evaporation method, a thermal evaporation method, a laser molecular beam epitaxy method, a pulsed laser deposition method, a sputtering method, or a vacuum vapor deposition method.

Among these methods, the sputtering deposition method is advantageous in that almost all types of metal thin films can be coated well, and in that a step coverage is also high, so that the shape of a coating film is hardly limited.

In terms of costs, it is advantageous to use a metal material having excellent conductivity such as aluminum or gold for the lower electrode. However, in the case where higher flexibility is required, the lower electrode may be configured with a flexible conductive material (organic thin film, silicon, or oxide conductive film).

The humidity-sensitive dielectric portion is a polymer layer of which capacitance changes according to the molecular weight of water to be adsorbed. The humidity-sensitive dielectric portion has a wide measurement range from 0 to 100% RH and a linear output depending on humidity.

The humidity-sensitive dielectric portion may be configured with a hydrophilic polymer material such as polymethyl methacrylate (PMMA), polyvinyl alcohol (PVA), polyethylene glycol (PEG), polyimide, or cellulose.

Since a polymer material itself has moisture absorbing properties, the polymer material has the advantage of being easy to reproduce the sensor characteristics. However, the polymer material is disadvantageous in that the polymer material cannot be used in a place of high temperature due to low heat resistance.

Polyimide has relatively high heat resistance and chemically stability, so that the polyimide can be used at a high temperature. Since the polyimide has a hydrophilic carbonyl group in its molecular structure, and thus, the polyimide is excellent in sensitivity to humidity according to a change in humidity and has linear sensitivity to humidity, resistance to chemicals, and good hysteresis properties. Therefore, it is advantageous to form the humidity-sensitive dielectric portion by stacking a polyimide-based polymer on the lower electrode by coating or the like.

For example, the humidity-sensitive dielectric portion can be formed by the following processes. When the lower electrode is formed, a wet etchable polymer solution as a moisture-sensitive layer is applied to the upper surface of the lower electrode by spin coating with a micro-thickness.

Herein, as the wet etchable polymer solution, a polyimide solution may be preferably used, and it is possible to apply the solution in an area larger than the area of the lower electrode layer.

When the pattern of the moisture-sensitive layer is formed, heat treatment is performed. Upon completion of the heat treatment, the polymer film is reduced in thickness by about 40% due to the evaporation of the solvent, and the polymer film is changed into a thermally, chemically stable state.

Next, the upper electrode can be formed on the polyimide film which is the moisture-sensitive layer after the heat treatment is completed. The upper electrode is an electrode for measuring the capacitance according to a change in dielectric constant of the humidity-sensitive dielectric portion together with the lower electrode.

For example, the upper electrode may be formed by using the same processes as the lower electrode.

For example, the upper electrode may be deposited on the humidity-sensitive dielectric portion by using an electron beam deposition method, a thermal evaporation method, a laser molecular beam epitaxy method, a pulsed laser deposition method, a sputtering method, or the like.

In terms of costs and quality, it is advantageous to perform deposition of the upper electrode by using the sputtering deposition method in which almost all types of metal thin films can be well coated and has a high step coverage so that the shape of the coating film is hardly limited.

Some or all of the upper electrode and the humidity-sensitive dielectric portion in contact with the upper electrode have patterns according to the present invention in order to widen the air exposure area of the humidity-sensitive dielectric portion.

For example, the patterns of the upper electrode may be formed by using a photolithography process or the like. When the patterned upper electrode is formed, an RIE process of etching the entire surface of the exposed humidity-sensitive dielectric portion with oxygen plasma can be performed by using the patterned upper electrode as a mask. In the RIE process, the entire surface of the exposed humidity-sensitive dielectric portion, for example, the polyimide film is etched by performing a photolithography process on the upper electrode. In the case of a polyimide film, an etching depth is preferably in a range of 20% to 80% of the total thickness of the polyimide film.

In another embodiment, a humidity-sensitive hole in the ringed cross-section may be formed by a perforation process to form the ringed cross-section of the upper electrode and the humidity-sensitive dielectric portion of the present invention.

For example, the humidity-sensitive hole may be formed in a circular grid pattern by using a micro-machining process.

For example, the micro-machining process may use ultrasonic machining, laser machining, or DRIE (Deep Reactive Ion Etch) process to simultaneously etch the upper electrode and the humidity-sensitive dielectric portion. The ultrasonic machining or laser machining is relatively inexpensive and easy to perforate holes as compared with the DRIE process, but the ultrasonic machining or laser machining has disadvantages in that hole roughness and uniformity of shape are deteriorated as compared with the DRIE process.

According to the embodiment, the exposed areas of the upper surface of the humidity-sensitive dielectric portion including the inner and outer walls of the cylinders may be subjected to hydrophilic treatment in order to improve water adsorption. For example, the hydrophilic treatment of the humidity-sensitive dielectric portion can be achieved through ultraviolet surface reformation where reformation is achieved by irradiating the inside of the humidity-sensitive hole with ultraviolet ray, or plasma surface reformation where reformation is achieved by supplying oxygen, nitrogen, argon, or sulfur hexafluoride plasma into the humidity-sensitive hole. In addition, the hydrophilic treatment may be performed by using a well-known reformation method such as reformation using corona discharge.

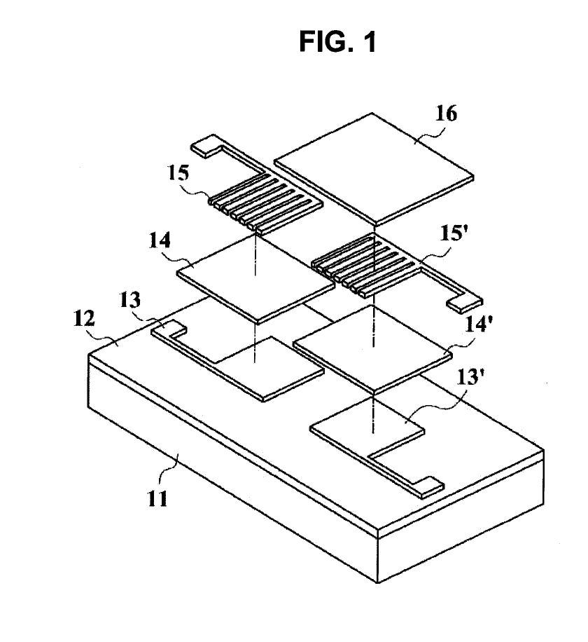

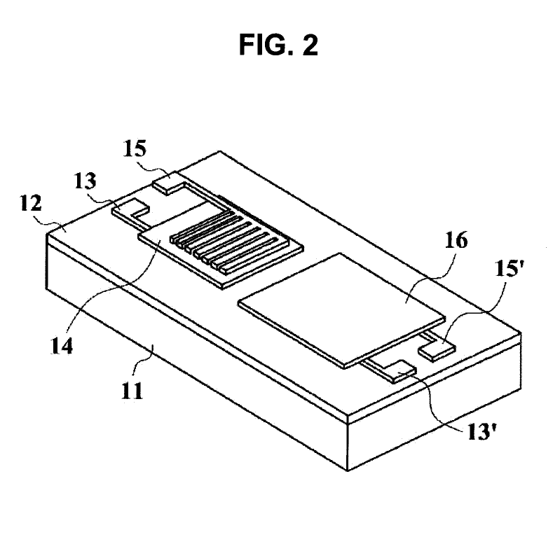

According to the embodiment, a comparative structure using the compensation element as illustrated in FIGS. 1 and 2 may be omitted, but it is advantageous in terms of accuracy to have the comparative structure using the compensation element.

Hereinafter, embodiments according to the present invention which can be manufactured by the above-described processes will be described.

### First Embodiment

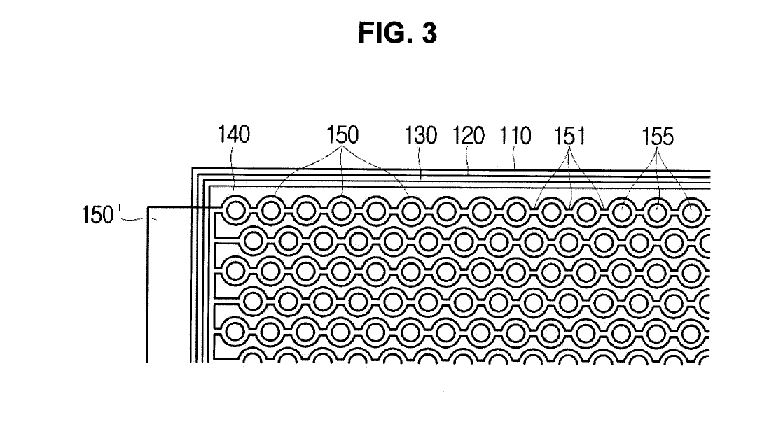

FIG. 3 is a plan view illustrating a top surface pattern of one sensing block constituting a capacitive humidity sensor according to an embodiment of the present invention.

The entire sensor may include a plurality of sensing blocks and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

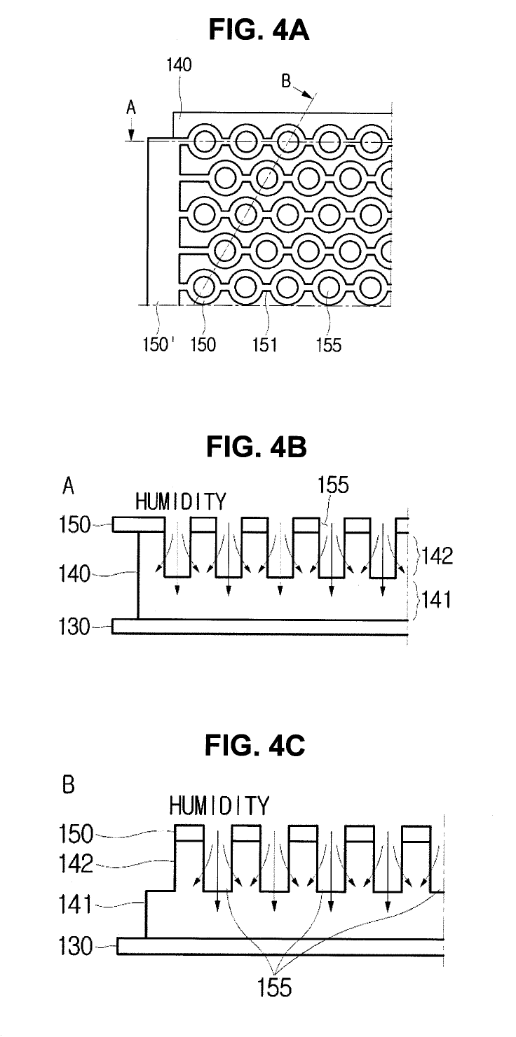

FIG. 4A illustrates a plan view of an enlarged structure for a partial region of the sensing blocks of FIG. 3. FIG. 4B illustrates a side cross-section of a region A illustrated in FIG. 4A. FIG. 4C illustrates a side cross-section of a region B illustrated in FIG. 4A.

As illustrated, a lower region 141 of the humidity-sensitive dielectric portion 140 in contact with the lower electrode 130 may be formed to have a sheet shape. An upper region 142 of the humidity-sensitive dielectric portion 140 may be formed in such a manner that cylinders having a circular-ringed cross-section in an upward direction in the sheet-shaped region are extended

In the case where the humidity-sensitive dielectric portion 140 is a polyimide film, an etching depth is preferably in a range of about 20% to 80% of the total thickness of the polyimide film. Therefore, in this case, about 20% to 80% of the lower portion of the humidity-sensitive dielectric portion 140 remains in a sheet shape, and about 80% to 20% of the upper portion of the humidity-sensitive dielectric portion 140 exists in a form of cylinders having a circular-ringed cross-section.

As illustrated, circular-ringed upper electrodes 150 are formed on the upper surfaces of the cylinders included in the humidity-sensitive dielectric portion 140. The circular-ringed upper electrodes 150 need to be conductively connected to a terminal for measurement of the capacitance. To this end, the two adjacent circular-ringed upper electrodes are connected to each other by interconnection portions 151 of the same material. In order to support the interconnection portion 151, the humidity-sensitive dielectric portion 140 remains under the interconnection portion. The upper electrodes 150 may form a region 150′ for connecting a terminal to one side of the sensor block.

Since the humidity-sensitive dielectric portion 140 remaining on the interconnection portion may cause non-uniformity depending on the direction of the humidity sensor, the narrower the interconnection portions 151 are, the more advantageous it is. However, the width of the interconnection portion 151 needs be secured to some extent in terms of securing the electrical conductivity of the upper electrode 150 and the mechanical strength and flexibility of the upper electrode 150 against bending. The width of the interconnection portion 151 is in a range of 0.5 to 1 times the width of the circular ring of the upper electrode 150, which is advantageous in terms of mechanical characteristics and easiness of application of the etching process.

According to the embodiment, the substrate 110 on which the humidity sensor block is formed is an ROIC substrate including electrode pads. A metal layer (not shown) formed on the ROIC substrate and patterned to expose portions of the electrode pads and an insulating layer 120 formed on the metal layer and patterned to expose portions of the electrode pads may be formed between the substrate 110 and the lower electrode 130.

It is preferable that the area porosity of patterns where a plurality of circular rings of the upper electrode 150 are connected to each other is in a range of 30 to 60%. Herein, the area porosity denotes a ratio of the area where the upper electrode 150 is not formed to the area of the upper surface illustrated in FIG. 3. If the area porosity of the patterns is in a range of 30 to 60%, the moisture penetration ratio can be maintained well while ensuring the sufficient storage capacity for detection sensitivity, and furthermore, there is an advantage that sufficient margin for deformation against the external bending force can be obtained.

As described above, the upper surfaces and upper substrate of the humidity-sensitive dielectric portion of the humidity sensor according to the embodiment have a pattern including a plurality of circular rings. According to the pattern, the humidity-sensitive dielectric portion can be precisely humidified in the air, but the upper substrate can have an effective area to secure the sufficient capacitance of the capacitor. As a result, the sensitivity of the humidity sensor is improved.

As described above, the humidity sensor of the humidity sensor according to the embodiment has a shape in which the upper partial area is etched in the form of a plurality of circular rings. The etched shape can maximize the contact area of the humidity-sensitive dielectric portion with air. As a result, the responsivity of the humidity sensor is improved.

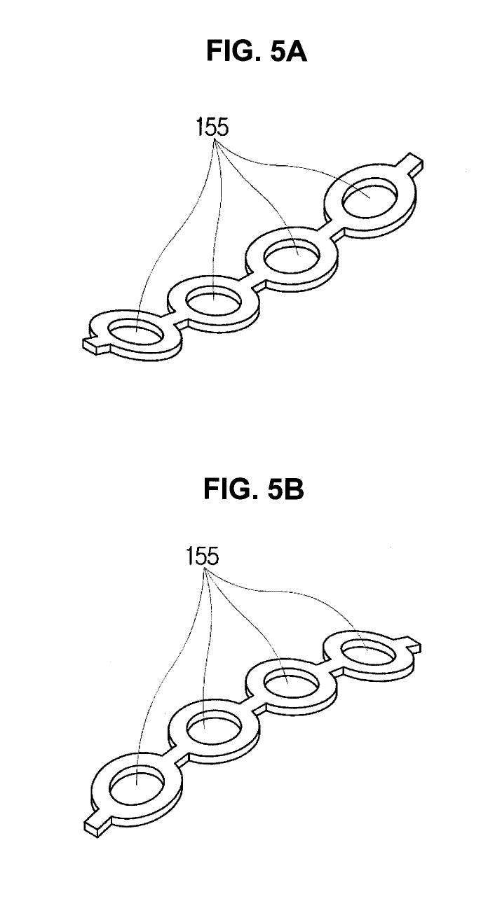

FIGS. 5A and 5B illustrate a state where a bending operation is applied to a partial region of the sensing blocks illustrated in FIG. 3. As illustrated, the entire structure configured with the cylindrical members (that is, cylinders having a circular-ringed cross-section) having hollows 155 has a room for being bent due to deformation of the hollow 155 into an elliptical shape by a bending force. Namely, the flexibility of the humidity sensor stack itself is enhanced. Therefore, even if there is some deformation due to the bending force, cutting of the upper electrode 150 can be prevented.

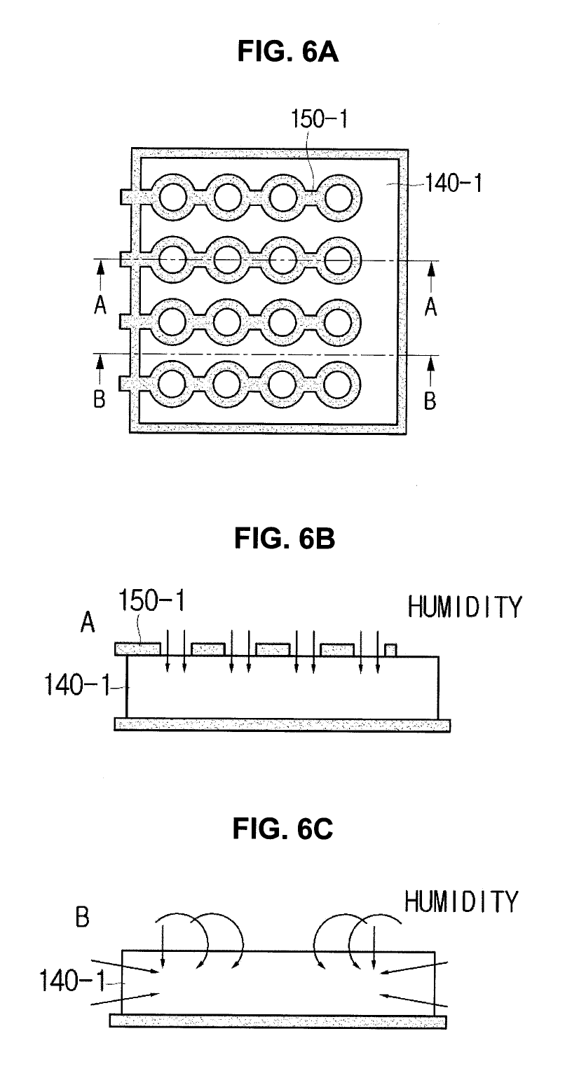

On the other hand, in other embodiments as illustrated in FIGS. 6A to 6C, the entire humidity-sensitive dielectric portion 140-1 may be formed in a sheet shape, and only the upper electrode 150-1 may have a pattern according to the spirit of the present invention.

### Second Embodiment

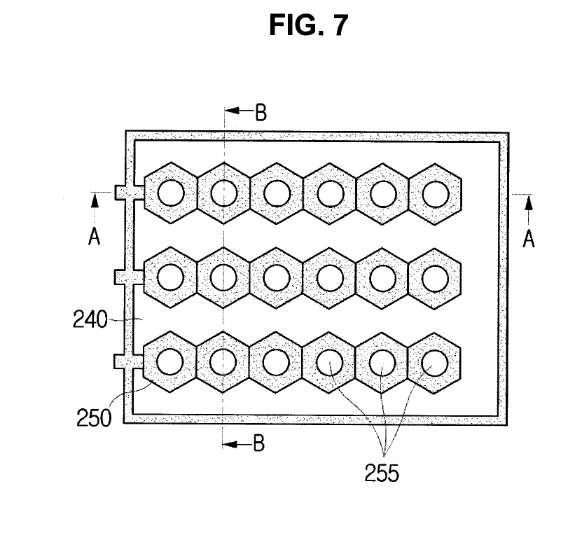

FIG. 7 is an enlarged plan view illustrating a top surface pattern of a partial region of one sensing block constituting the capacitive humidity sensor according to another embodiment of the present invention.

The entire sensor may include a plurality of sensing blocks, and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

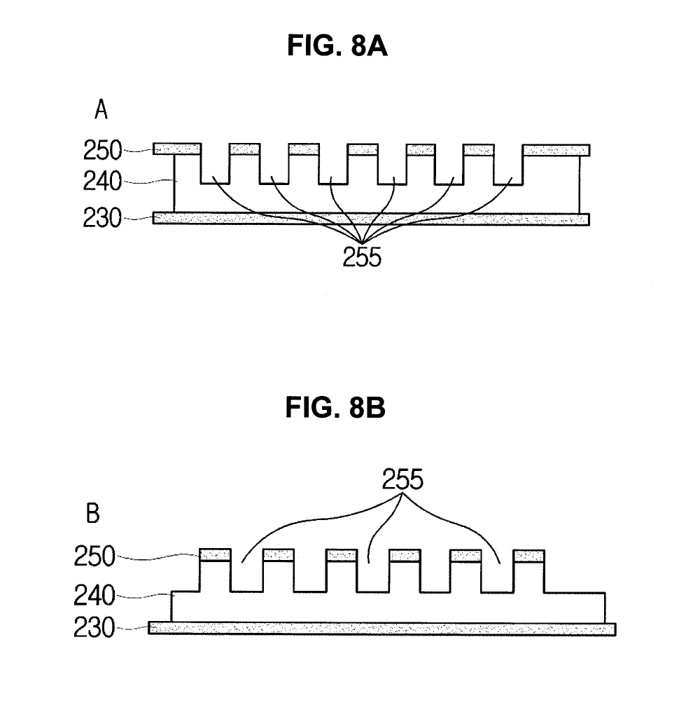

FIG. 8A illustrates a side cross-sectional view of a region A illustrated in FIG. 7, and FIG. 8B illustrates a side cross-sectional view of a region B illustrated in FIG. 7.

As illustrated, a lower region of a humidity-sensitive dielectric portion 240 in contact with the lower electrode 230 may be formed to have a sheet shape. The humidity-sensitive dielectric portion 240 may be formed in such a manner that cylinders having a circular-ringed cross-section in an upward direction in the sheet-shaped region are extended. By the way, it can be seen that the inner walls of the cylinders in which the hollows 255 are formed are circular, but the outer walls are hexagonal. In the embodiment in which the upper electrode has a hexagonal outer wall, there is an advantage that a charging area can be sufficiently secured in a capacitive structure. In the embodiment in which the humidity-sensitive dielectric portion 240 has a hexagonal outer wall, there is an advantage in that an etching process is adaptable to a fine pattern. In other words, it is easy to manufacture the humidity sensor having a very fine structure by using the etching process of the cylinders in which the hollows 255 are formed.

In the case where the humidity-sensitive dielectric portion 240 is a polyimide film, an etching depth is preferably in a range of 20% to 80% of the total thickness of the polyimide film. In this case, about 20% to 80% of the lower portion of the humidity-sensitive dielectric portion 240 remains in a sheet shape, and about 80% to 20% of the upper portion of the humidity-sensitive dielectric portion 240 exists in a form of cylinders having a hexagonal outer wall and having a circular-ringed cross-section.

In other embodiments, the entire humidity-sensitive dielectric portion may be formed in a sheet shape, and only the upper electrode may have a pattern according to the spirit of the present invention.

As illustrated, circular-ringed upper electrodes 250 having a circular inner wall and a hexagonal outer wall are formed on the upper surfaces of the cylinders included in the humidity-sensitive dielectric portion 240. The ringed upper electrodes 250 need to be conductively connected in such a manner that the adjacent upper electrodes are in contact with each other.

It is preferable that the area porosity of patterns where a plurality of circular rings of the upper electrodes 250 are connected to each other is in a range of 30 to 60%.

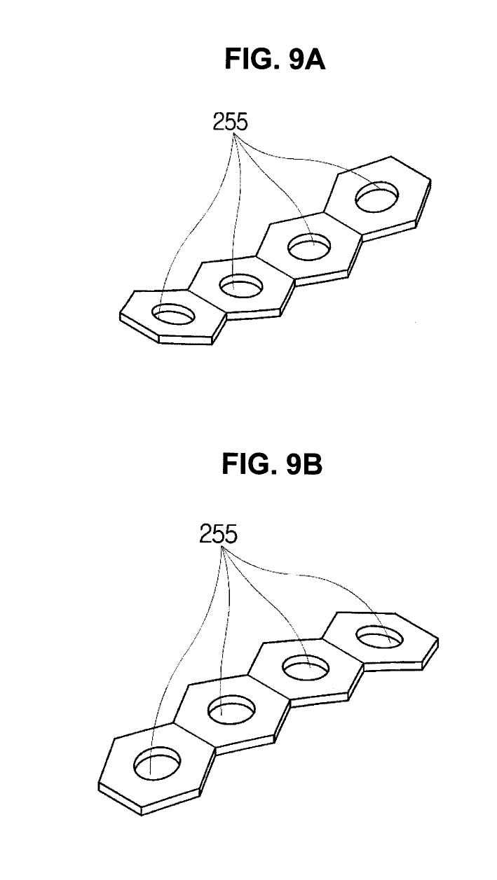

FIGS. 9A and 9B illustrate a state where a bending operation is applied to a partial region of the sensing block illustrated in FIG. 7. As illustrated, the entire structure configured with the cylindrical members (that is, cylinders having a circular-ringed cross-section having hexagonal outer walls) having hollows 255 has a room for being bent due to deformation of the hollow 255 into an elliptical shape by a bending force. In addition, interconnected hexagonal outer walls provide higher tensile resistance. Therefore, even if a considerably large force is exerted in the bending direction, cutting of the upper electrode 250 can be prevented.

### Third Embodiment

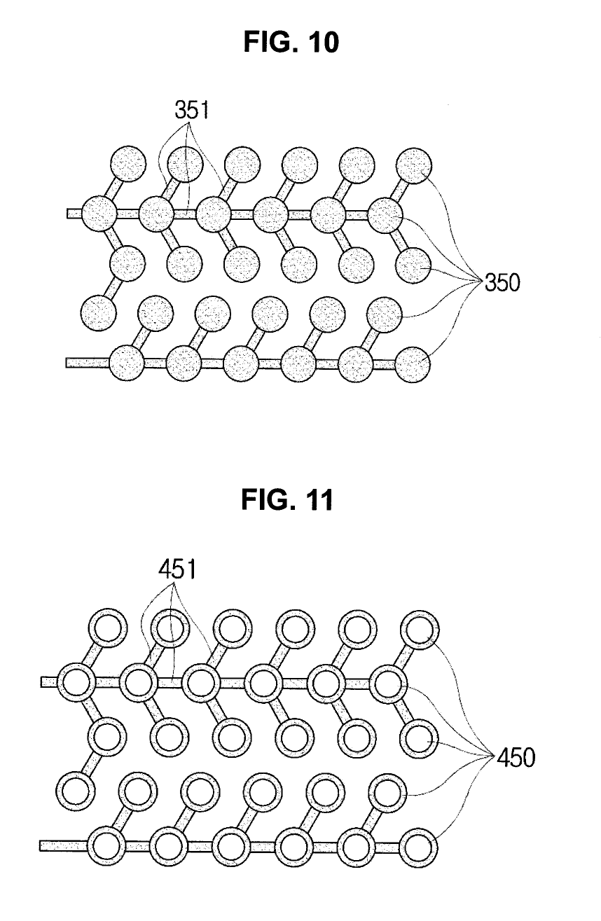

FIG. 10 is a plan view illustrating a top surface pattern of one sensing block constituting a capacitive humidity sensor according to still another embodiment of the present invention.

The entire sensor may include a plurality of sensing blocks and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

A lower region of the humidity-sensitive dielectric portion in contact with the lower electrode may be formed to have a sheet shape, and the humidity-sensitive dielectric portion may be formed in such a manner that cylinders having a circular-ringed cross-section in an upward direction in the sheet-shaped region are extended.

If the humidity-sensitive dielectric portion is a polyimide film, an etching depth is preferably in a range of about 20% to 80% of the total thickness of the polyimide film. In this case, about 20% to 80% under the humidity-sensitive dielectric portion remain in a sheet shape, and about 20% above the humidity-sensitive dielectric portion exists in a shape of cylinders having a circular-ringed cross-section.

In other embodiments, the entire humidity-sensitive dielectric portion may be formed in a sheet shape, and only the upper electrode may have a cylindrical pattern.

As illustrated, circular upper electrodes 350 are formed on the upper surfaces of the cylinders included in the humidity-sensitive dielectric portion, and two adjacent circular upper electrodes 350 are connected to each other by the interconnection portions 351 of the same material. In order to support the interconnection portion 351, the humidity-sensitive dielectric portion also remains under the interconnection portion.

⅓ of the total number of the interconnection portions 351 of the plurality of circular rings illustrated are formed at an angle of 0 degree, the other ⅓ of the total number of the interconnection portions are formed at an angle of 60 degrees, and the remaining ⅓ of the total number of the interconnection portions are formed at an angle of 120 degrees. In other words, the three sides constituting an equilateral triangle are distributed in the same number. Accordingly, the humidity sensor having the humidity-sensitive dielectric portion pattern according to the embodiment can have sensitivity independent of the direction of the air flow at the installation position of the sensor.

It is preferable that the area porosity of patterns where a plurality of circular rings of the upper electrodes 350 are connected to each other is in a range of 30 to 60%.

### Fourth Embodiment

FIG. 11 is a plan view illustrating a top surface pattern of one sensing block constituting a capacitive humidity sensor according to still another embodiment of the present invention.

The entire sensor may include a plurality of sensing blocks and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

A lower region of the humidity-sensitive dielectric portion in contact with the lower electrode may be formed to have a sheet shape, and a humidity-sensitive dielectric portion may be formed in such a manner that the cylinders having a circular-ringed cross-section in the upward direction in the sheet-shaped region are extended.

In the case where the humidity-sensitive dielectric portion is a polyimide film, an etching depth is preferably about 20% to 80% of the total thickness of the polyimide film. In this case, about 20% to 80% of the lower portion of the humidity-sensitive dielectric portion remains in a sheet shape, and about 80% to 20% of the upper portion of the humidity-sensitive dielectric portion exists in a form of cylinders having a circular-ringed cross-section.

In other embodiments, the entire humidity-sensitive dielectric portion may be formed in a sheet shape, and only the upper electrode may have a pattern of cylinders having a circular-ringed cross-section.

As illustrated, circular-ringed upper electrodes 450 are formed on the upper surfaces of the cylinders included in the humidity-sensitive dielectric portion, and the two adjacent circular-ringed upper electrodes 450 are connected to each other by interconnection portions 451 made of the same material. In order to support the interconnection portion 451, the humidity-sensitive dielectric portion also remains under the interconnection portion. The width of the interconnection portion 451 is in a range of 0.5 to 1 times the width of the circular ring of the upper electrode 450, which is advantageous in terms of mechanical characteristics and easiness of application of the etching process.

⅓ of the total number of the interconnection portions 451 of the plurality of circular rings illustrated are formed at an angle of 0 degree, the other ⅓ of the total number of the interconnection portions are formed at an angle of 60 degrees, and the remaining ⅓ of the total number of the interconnection portions are formed at an angle of 120 degrees. Namely, the three sides constituting an equilateral triangle are distributed in the same number. Accordingly, the humidity sensor having the humidity-sensitive dielectric portion pattern according to the embodiment can have sensitivity independent of the direction of the air flow at the installation position of the sensor

It is preferable that the area porosity of patterns where a plurality of circular rings of the upper electrode 450 are connected to each other is in a range of 30 to 60%.

### Fifth Embodiment

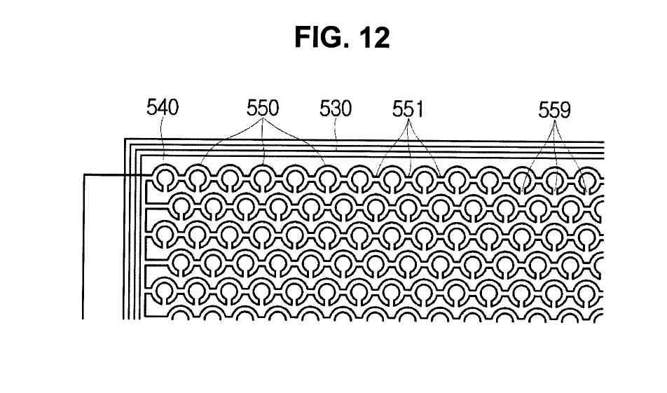

FIG. 12 is a plan view illustrating a top surface pattern of one sensing block constituting the capacitive humidity sensor according to further still another embodiment of the present invention.

The entire sensor may include a plurality of sensing blocks and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

A lower region of the humidity-sensitive dielectric portion 540 in contact with the lower electrode 530 may be formed have a sheet shape, and the humidity-sensitive dielectric portion 540 may be formed in such a manner that the cylinders having a C-ringed cross-section in an upward direction in the sheet-shaped region are extended.

In the case where the humidity-sensitive dielectric portion 540 is a polyimide film, an etching depth is preferably about 20% to 80% of the total thickness of the polyimide film. In this case, about 20% to about 80% of the lower portion of the humidity-sensitive dielectric portion 540 remains in a sheet shape, and about 80% to 20% of the upper portion of the humidity-sensitive dielectric portion 540 exists in a form of cylinders having a C-ringed cross-section.

In other embodiments, the entire humidity-sensitive dielectric portion 540 may be formed in a sheet shape, and only the upper electrode 550 may have a pattern of cylinders having a C-ringed cross-section.

As illustrated, C-ringed upper electrodes 550 are formed on the upper surfaces of the cylinders included in the humidity-sensitive dielectric portion 540. The C-ringed upper electrodes 550 need to be conductively connected to a terminal for measurement of the capacitance. To this end, the two adjacent C-ringed upper electrodes 550 are connected to each other by interconnection portions 551 of the same material. In order to support the interconnection portion 551, a humidity-sensitive dielectric portion 540 also remains under the interconnection portion.

The width of the interconnection portion 551 is in a range of 0.5 to 1 times the width of the C-ring of the upper electrode 550, which is advantageous in terms of mechanical characteristics and easiness of application of the etching process.

In the case where the thickness of the humidity-sensitive dielectric portion 540 is considerably large, it is easier to form the cylinders having a C-ringed cross-section than to form the cylinders having a circular-ringed cross-section by using an etching process. Of course, it is possible to form the cylinders having a circular-ringed cross-section by using an additional perforation process as described in the first embodiment, but the additional process has the disadvantage of additional costs.

It is preferable that the area porosity of patterns where a plurality of the C-rings of the upper electrode 550 are connected to each other is in a range of 30 to 60%.

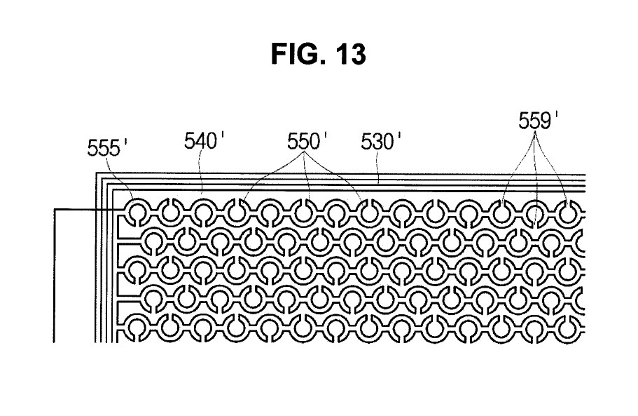

The humidity sensor illustrated in FIG. 13 is different from that of FIG. 12 in that openings 559′ of the C-ring constituting the upper electrode 550′ are alternately arranged in the upward and downward directions.

Since a larger amount of air can be introduced into the inner surfaces of the cylinders through the openings 559′ of the C-rings than through the hollows 555′ of the upper electrodes 550′, the openings 559′ of the C-rings may cause non-uniformity in the direction of the humidity sensor. In order to suppress the non-uniformity, in the case of the humidity sensor illustrated, there may be used a pattern where the opening directions of the openings 559′ of the C-rings are alternately distributed in the upward and downward directions. In this case, a total sum of vectors of the directions of the C-ringed openings 559′ with respect to the center point of the plurality of C-rings becomes zero.

### Sixth Embodiment

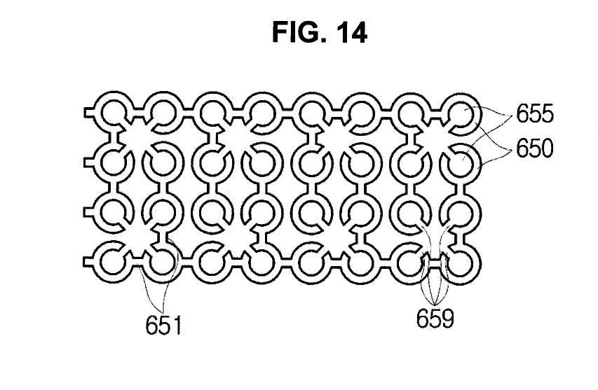

FIG. 14 is a plan view illustrating a top surface pattern of one sensing block constituting a capacitive humidity sensor according to yet further still another embodiment of the present invention.

The entire sensor may include a plurality of sensing blocks and may further include a sensing signal detection circuit, an electrode pad for external connection, and the like. On the other hand, one or more of the plurality of sensing blocks included in one sensor may be encapsulated with a material which is not permeable to moisture in order to generate a reference signal. The plurality of sensing blocks included in one sensor may have a structure similar to that of FIGS. 1 and 2.

A lower region of the humidity-sensitive dielectric portion in contact with the lower electrode may be formed to have a sheet shape, and the humidity-sensitive dielectric portion may be formed in such a manner that the cylinders having a C-ringed cross-section in the upward direction in the sheet-shaped region are extended.

In the case where the humidity-sensitive dielectric portion is a polyimide film, an etching depth is preferably about 20% to 80% of the total thickness of the polyimide film. In this case, about 20% to 80% of the lower portion of the humidity-sensitive dielectric portion remains in a sheet shape, and about 80% to 20% of the upper portion of the humidity-sensitive dielectric portion exists in a form of cylinders having a C-ringed cross-section.

In other embodiments, the entire humidity-sensitive dielectric portion may be formed in a sheet shape, and only the upper electrode may have a pattern of cylinders having a C-ringed cross-section.

As illustrated, C-ringed upper electrodes 650 are formed on the upper surfaces of the cylinders included in the humidity-sensitive dielectric portion. The C-ringed upper electrodes 650 need to be conductively connected to a terminal for measurement of the capacitance. To this end, the two adjacent C-ringed upper electrodes 650 are connected to each other by interconnection portions 651 of the same material. In order to support the interconnection portions 651, the humidity-sensitive dielectric portion also remains under the interconnection portion.

The width of the interconnection portion is in a range of 0.5 to 1 times the width of the C-ring of the upper electrode 650, which is advantageous in terms of mechanical characteristics and easiness of application of the etching process.

Since a larger amount of air can be introduced into the inner surfaces of the cylinders through the openings 659 of the C-rings than through the hollows 655 of the upper electrode 650, the openings 659 of the C-rings may cause non-uniformity in the direction of the humidity sensor. In order to suppress the non-uniformity, in the case of the humidity sensor according to the embodiment, there may be used a pattern where the opening directions of the openings 659 of the C-rings are distributed uniformly in the radial direction. In the most preferable pattern, the opening directions are uniformly distributed with respect to all angles of one rotation of 360 degrees is the most preferable. However, in terms of easiness of the manufacturing process, it is advantageous to have a pattern in which the opening directions of the openings 659 of the C-rings are distributed uniformly at angles obtained by dividing 360 degrees by a certain integer. In this case, a total sum of vectors of the directions of the C-ringed openings 659 with respect to the center point of the plurality of C-rings becomes zero.

½ of the total number of the interconnection portions 651 of the plurality of C-rings illustrated are formed at an angle of 0 degree, and the other ½ of the total number of the interconnection portions are formed at an angle of f 90 degrees. Namely, the four sides constituting a square are distributed in the same number. Accordingly, the humidity sensor having the humidity-sensitive dielectric portion pattern according to embodiment can have sensitivity independent of the direction of the air flow at the installation position of the sensor.

It should be noted that the above-described embodiments is for the purpose of illustration, and not for limitation thereof. In addition, it will be understood by the ordinarily skilled in the art that various embodiments are possible within the scope of the present invention.

What is claimed is:

1. A humidity sensor including a substrate, a lower electrode, a humidity-sensitive dielectric portion, and an upper electrode which are sequentially stacked and measuring humidity by sensing a difference in capacitance between electrodes according to a change in dielectric constant of the humidity-sensitive dielectric portion,
wherein the humidity-sensitive dielectric portion has a plurality of cylindrical members having a circular or C-shaped cross-section erected on the lower electrode, and
wherein the upper electrode has a pattern where a plurality of circular-rings or C-rings in contact with ceiling surfaces of the plurality of the cylindrical members of the humidity-sensitive dielectric portion are connected to each other.

2. The humidity sensor according to claim 1, wherein the plurality of C-rings are formed such that a total sum of vectors of the C-ringed opening directions with respect to a center point thereof is zero.

3. The humidity sensor according to claim 1, wherein a shape of distribution of interconnection portions of the plurality of circular-rings or C-rings is a shape where sides constituting a regular polygon are distributed in the same number.

4. The humidity sensor according to claim 1, wherein a width of interconnection portions of the plurality of circular-rings or C-rings has a value of 0.5 to 1 times the width of the circular-ring or C-ring.

5. The humidity sensor according to claim 1, wherein an area porosity of patterns where the plurality of circular-rings or C-rings of the upper electrode are connected to each other is in a range of 30% to 60%.

6. The humidity sensor according to claim 1, wherein the humidity-sensitive dielectric portion is made of a polyimide-based polymer, and an etching depth is in a range of 20% to 80% of a thickness of the humidity-sensitive dielectric portion.
